(19) United States
(12) Patent Application Publication
(10) Pub. No.: US 2003/0212905 A1
(43) Pub. Date: Nov. 13, 2003

(54) Method, computer product and network to regulate software licensure authentication in a computer network environment

(75) Inventors: Trung M. Tran, Round Rock, TX (US); Alan C. Folta, Austin, TX (US)

Correspondence Address: ZAGORIN O'BRIEN & GRAHAM LLP, 401 W 15TH STREET, SUITE 870, AUSTIN, TX, 78701, US

(73) Assignee: SUN MICROSYSTEMS, INC., Palo Alto, CA

(21) Appl. No.: 10/141,012

(22) Filed: May 8, 2002

(51) Int. Cl. H04L 9/00

(52) U.S. Cl. 713/201; 705/59

(57) ABSTRACT

Provided are a method, a computer product and a network to manage software licensing over a distributed network using a master license compliance software program by creating multiple copies of the license compliance software programs. The master license compliance program and the multiple copies define a plurality of the license compliance software programs, each of which has software license rights associated therewith. Referral priority levels are associated with each of the plurality of license compliance software programs to define a referral sequence. The master license compliance program receives a license request and refers the license request to the multiple copies of license compliance software programs. The request is transmitted in accordance with the referral sequence to obtain license authorization, were the master license compliance program to fail to grant the request.

### BACKGROUND OF THE INVENTION

The present invention relates electronic licensing, and more specifically the authentication of software licensure in a computer network environment.

Computer networks facilitate collaborative efforts of several individuals remotely disposed from one another. Typically, a computer network includes a plurality of users employing client computers communicating with one or more remote server computers to transfer data therebetween and allow access to one or more software programs. Computer networks, however, have presented a challenge with ensuring that the license rights associated with software programs are adhered to. For example, in a non-networked environment, ensuring that the license rights are adhered to is typically accomplished on a user-by-user basis. To that end, the license rights are based upon the number of physical copies of a computer software program (e.g., application, operating system, etc.) purchased by the user.

In a networking environment, however, the number of users authorized to access a software program may be independent of a number of physical copies of the software program. For example, one physical copy of a software program may be licensed for use by multiple users. As a result, the licensing rights of the software program may be defined in a variety of manners. One copy of a software program accessed over a computer network may be licensed for a certain number of users, or a certain number of terminal connections, or both.

A typical prior art example of software license management over a network is discussed with respect to FIG. 1 and includes a server 10 and a client 20. Server 10 and client 20 are in data communication over a network to facilitate execution of a license confirmation program. Upon client 20's request to access a software program, a license confirmation request program is executed. This license confirmation request program transmits a license confirmation request as well as a license information file that client 20 transmits to server 10. Upon receipt of the confirmation request, server 10 executes a standby license confirmation program that authenticates the operational environment by referring to the license information file transmitted from client 20. Server 10 transmits the confirmation result to the client 20 through the network. Were client 20 authenticated, server 10 permits access by client 20 to the software program.

A drawback with the aforementioned license authentication is that the license confirmation program may be unavailable due to excessive data traffic between server 10 and other users (not shown) or failure of server 10.

U.S. Pat. No. 6,023,766 to Yamamura discloses a software license control system that reduces problems associated with excessive data traffic by incorporating license authentication by electronic mail. To that end, the software license control system includes software execution equipment that executes installed software, and software license control equipment that controls the license for the software. The software license control system is characterized by interchanging information on the license for software between the software execution equipment and the software license control equipment by means of electronic mail. Thus, according to the software license control system and software license control equipment of the invention, the information on a license for software is interchanged between the software execution equipment and the software license control equipment by means of electronic mail.

A need exists, however, to provide license authentication when presented with a catastrophic failure of a licensing software program.

### SUMMARY OF THE INVENTION

The present invention provides a method, computer product and a network to manage software licensing over a distributed network using a master license compliance software program and multiple copies of license compliance software programs. The master license compliance program and the multiple copies define a plurality of the license compliance software programs, each of which has software license rights associated therewith. Referral priority levels are associated with each of the plurality of license compliance software programs to define a referral sequence. The master license compliance program receives a license request and refers the license request to the multiple copies of license compliance software programs. The request is transmitted in accordance with the referral sequence to obtain license authorization, were the master license compliance program to fail to grant the request.

### BRIEF DESCRIPTION OF THE DRAWINGS

FIG. 1 is a plan view of a prior art licensing management system;

FIG. 2 is a simplified plan view of a computer network in which the present invention is implemented;

FIG. 3 is a block diagram of a client terminal shown in FIG. 2;

FIG. 4 is a flow diagram of a method to manage software licenses in accordance with one embodiment of the present invention;

FIG. 5 is a flow diagram of a method to process multiple license requests in accordance with another embodiment of the present invention; and

FIGS. 6a and 6b are flow diagrams of a method to process multiple license requests in accordance with another embodiment of the present invention.

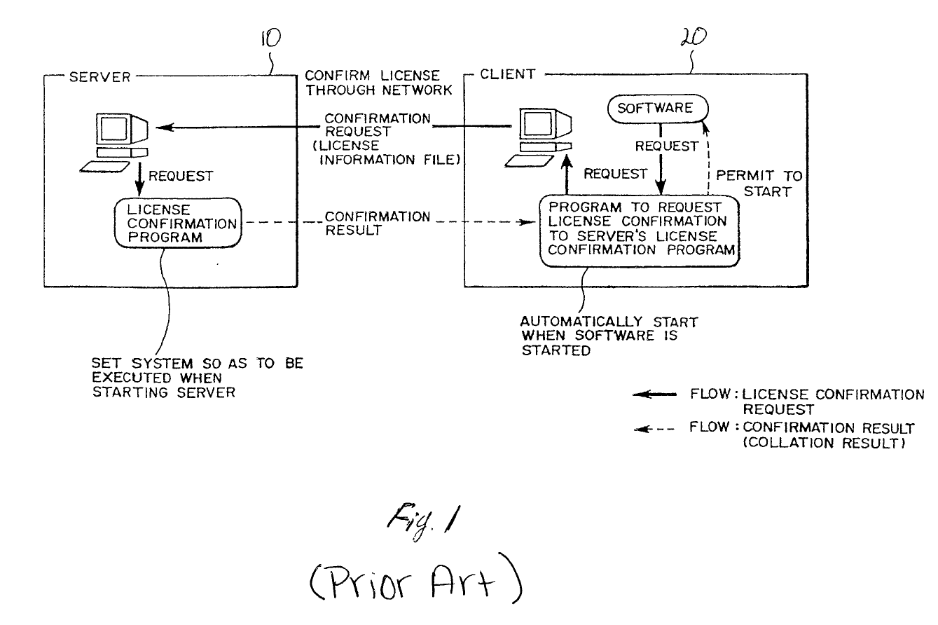

### DETAILED DESCRIPTION OF THE PREFERRED EMBODIMENTS

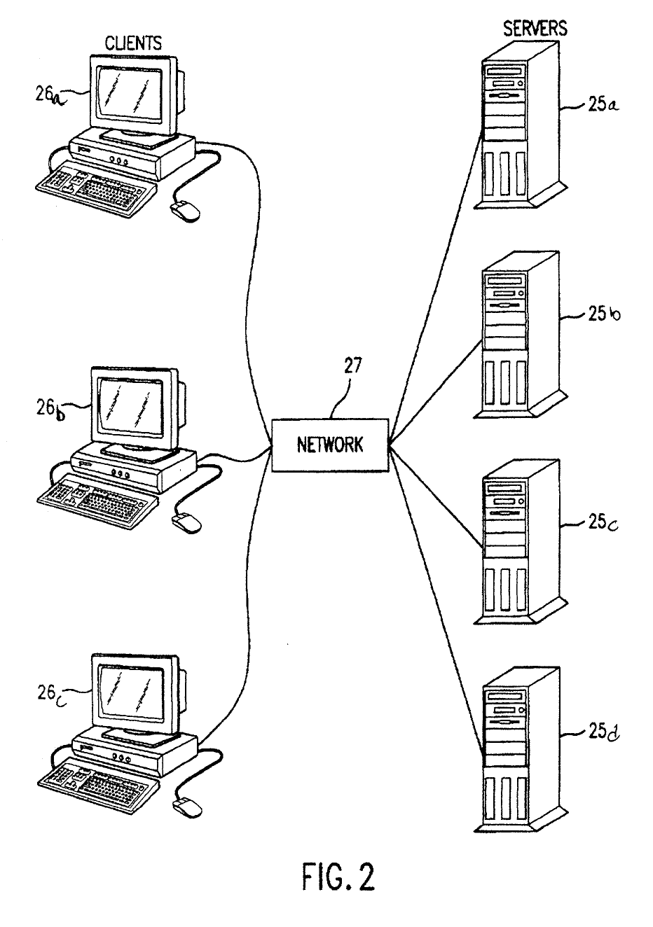

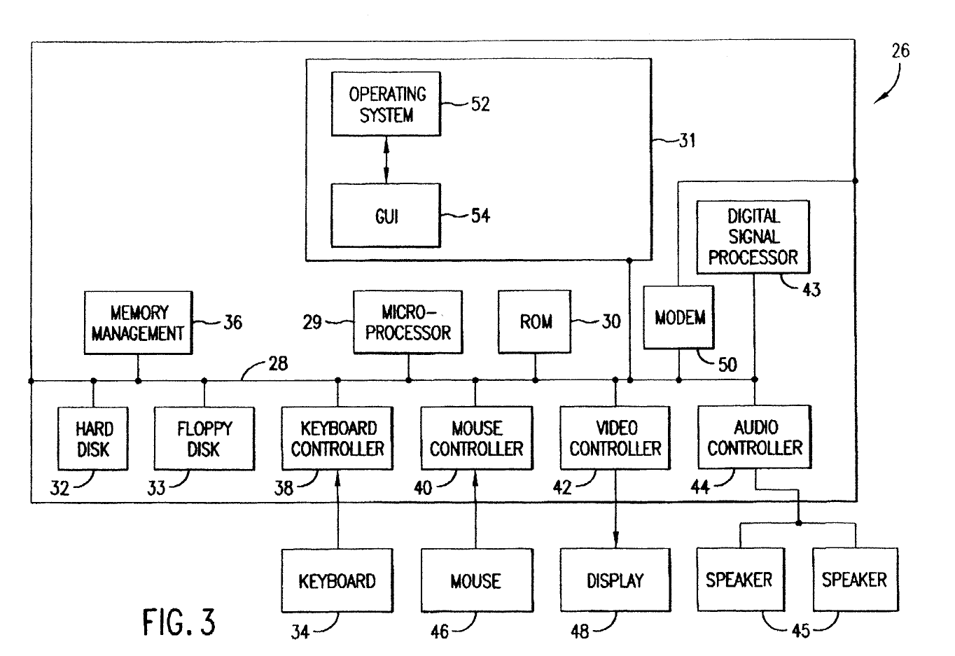

Referring to FIG. 2, shown is a plurality of servers 25a, 25b, 25c and 25d accessible by client terminals 26a, 26b and 26c over a network 27. Communication between servers 25a, 25b, 25c and 25d and client terminals 26a, 26b and 26c may be over a public network, such as a public switched telephone network, over ASDL telephone lines or large bandwidth trunks, such as Tl or OC3 service. Alternatively, client terminals 26a, 26b and 26c may communicate with servers 25a, 25b, 25c and 25d over a local area network. In the present example, the invention is discussed with respect to communication over a network employing Ethernet protocols. To facilitate communication over network 27, client terminals 26a, 26b and 26c execute application specific software, to produce a user interface, shown more clearly in FIG. 3.

Referring to FIGS. 2 and 3, each of the client terminals 26a, 26b and 26c includes one or more system buses 28 placing various components thereof in data communication. For example, a microprocessor 29 is placed in data communication with both a read only memory (ROM) 30 and random access memory (RAM) 31 via system bus 28. ROM 30 contains among other code, the Basic Input-Output System (BIOS) that controls basic hardware operation such as the interaction with peripheral components, e.g., disk drives 32 and 33, and keyboard 34.

RAM 31 is the main memory into which the operating system and application programs are loaded and affords at least 32 megabytes of memory space. A memory management chip 36 is in data communication with system bus 28 to control direct memory access (DMA) operations. DMA operations include passing data between the RAM 31 and the hard disk drive 32 and the floppy disk drive 33.

Also in data communication with system bus 28 are various I/O controllers: a keyboard controller 38, a mouse controller 40, a video controller 42, and an audio controller 44, which may be connected to one or more speakers 45. Keyboard controller 38 provides a hardware interface for keyboard 34, and mouse controller 40 provides a hardware interface for a mouse 46, or other point and click device. Video controller 42 provides a hardware interface for a display 48. A Network Interface Card (NIC) 50 enables data communication over the network facilitating data transmission speeds up to 1000 megabytes per second. The operating system 52 of the client terminal 26 may be UNIX, LINUX, DOS, WINDOWS-based or any known operating system.

User interface, which in the present example is a graphics driven interface referred to as a (GUI) 54, is loaded in RAM 31 to facilitate running application specific software stored on one of servers 25a, 25b, 25c or 25d. For example, GUI 54 may facilitate access to a software tool employed to design integrated circuits, such as a Composer Tool available from Cadence Design Systems and is stored on one of servers 25a, 25b, 25c or 25d.

Access to the software tool by client terminal 26a, 26b and 26c requires compliance with a license for use of the software tool. To ensure compliance, client terminal 26a transmits a license request to a master license compliance software program that may be stored on one or more of servers 25a, 25b, 25c and 25d. In response to the license request, the master license compliance software program stored, for example, on server 25b, executes and determines whether the request is within the scope of the license that defines the access rights to the software tool. For example, the master license compliance software program may determine whether the amount of clients 26a, 26b and 26c authorized to access the software tool concurrently has been exceeded. Were the number of clients 26a, 26b and 26c accessing the software tool not found to exceed a maximum number, the master license compliance software transmits a grant access command as well as a license information file to client terminal 26a. Client terminal 26a then transmits the same to server 25a upon which the software tool is stored. Upon receipt of the grant access command, server 25a authenticates the grant access command by referring to the license information file transmitted from client terminal 26a. Server 25a transmits the confirmation result to client terminal 26a through network 27 and allows access to the software tool. Were the master license compliance software to fail to transmit a grant access command to client terminal 26a, client terminal 26a would not be provided access to the software tool on server 25a.

The present invention, however, takes advantage of the network over which client terminal 26a communicates with servers 25a, 25b, 25c and 25d to search out grant access commands from other license compliance programs in communication with client terminals 26a, 26b and 26c over network 27. To that end, one embodiment of the present invention employs the light-weight directory protocol LDAP to access license information stored on one or more of servers 25a, 25b, 25c and 25d. Employing LDAP, advantage is taken of the referral features of the protocol by referring a license request, for which no grant access command is received in response thereto, to other license compliance programs that may be placed in data communication with client terminal 26a over network 27. These other license compliance programs are named referred license compliance programs, because they receive license requests referred thereto by client 20 as a result of the master license compliance program failing to transmit a grant access command.

Specifically, the referred license compliance programs are stored on servers other than the server upon which the master license compliance program is stored. The servers upon which the referred license compliance programs are stored may be disposed remotely from each other, as well as from the server upon which the master license compliance program is stored and the client terminal.

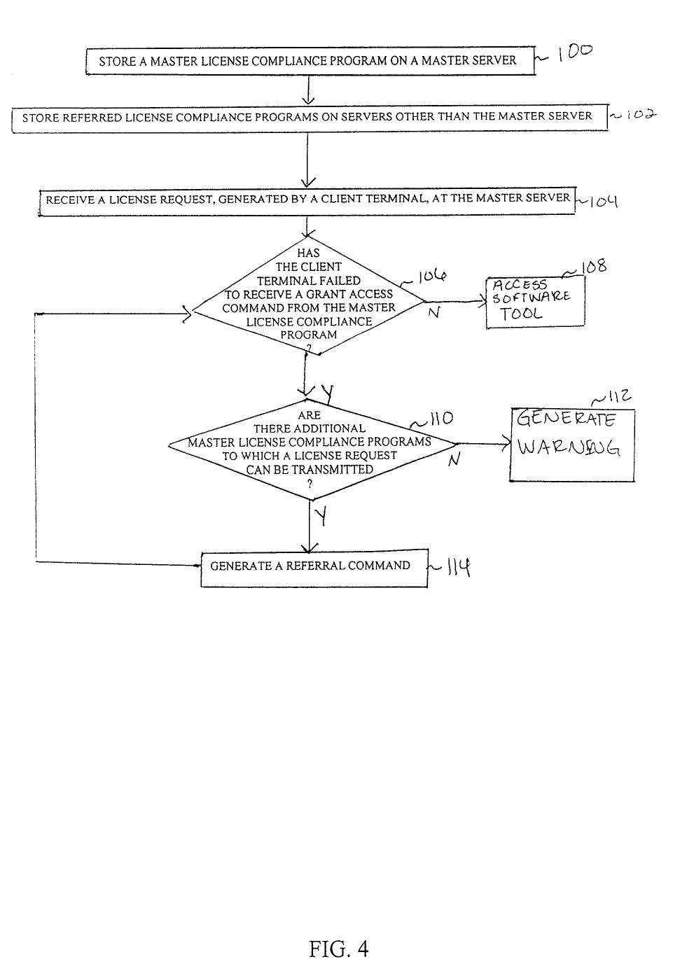

Referring to FIGS. 2 and 4, in an exemplary license management technique, the master license compliance program is stored on a master server, such as server 25b at step 100. The referred license compliance programs are stored on servers 25a, 25c and 25d, at step 102. At step 104, a license request, generated by client terminal 26a, is received by master server 25b. At step 106, it is determined whether client terminal 26a received a grant access command. Were a grant access command received by client terminal 26a, then access to the software tool is allowed at step 108. Were the client terminal 26a to fail to receive a grant access command, then client terminal 26a determines whether there are additional referred license compliance programs from which a grant access command may be obtained, at step 110. Were it determined, at step 110, that there were no additional master license compliance programs to which to transmit a license request, then a warning is generated at step 112. The warning may be generated at client terminal 26a and may contain audio stimuli, visual stimuli, or both. Were it determined that there were additional referred license programs to which a license request could be transmitted at step 110, then client terminal 26a executes a referral subroutine that generates a referral command, at step 114. After the referral command has been generated, the technique returns to step 106. Steps 106, 110 and 114 are repeated until access to the software tool has been granted at step 108, or a warning is generated at step 112. In this manner, referral subroutine sequentially transmits a license request to the referred license compliance program contained on each of servers 25a, 25c and 25d. The sequence in which servers 25a, 25c and 25d receive a license request is dictated by the priority level associated with the referred license compliance program, defining a referral sequence. To that end, the referral subroutine contains information concerning the location of the referred license compliance programs, as well as a priority level associated with each.

In one example, client terminal 26a may transmit a license request to the license compliance program with the highest priority level first. Were server 25b to determine that the maximum number of users had been reached for the software tool, server 25b transmits a denied access command, indicating that no access could be granted. In response to the denied access command, client terminal 26a proceeds to transmit a license request from the license compliance program having the next highest level of priority. This process continues until a license grant access command is received. Were a request sent to each of the referred license compliance programs in the referral sequence and client terminal 26a fails to receive a grant access command, a warning would be provided at the client terminal 26a.

As stated above, servers 25a, 25b, 25c and 25d may be disposed remotely from each other, as well as from clients 26a, 26b and 26c. To that end, servers 25a, 25b, 25c and 25d may have different geographical, organizational, political associations or a combination thereof. Depending upon the geographical definitions, servers 25a, 25b, 25c and 25d may have a common geographical association by being contained in a common building, a common room within a building and the like. Alternatively, servers 25a, 25b, 25c and 25d may have differing geographical associations by being located in differing buildings or in differing rooms of a common building. Similarly, depending upon the organizational definitions, servers 25a, 25b, 25c and 25d may have a common organizational association by being associated with a common company, or a common subunit within a company. Alternatively, servers 25a, 25b, 25c and 25d may have differing organizational associations by being associated with differing companies or with differing subunits of a common company. Depending upon the definition of political associations, servers 25a, 25b, 25c and 25d may have a common political association by being contained in a common nation, or a common political subdivision of a common nation. Alternatively, servers 25a, 25b, 25c and 25d may have differing political associations by being associated with differing nations or within differing political subdivisions of a common nation.

The priority level associated with each of servers 25a, 25b, 25c and 25d may be dependent upon any of the aforementioned geographical, organizational and political associations. For example, client terminal 26a could choose to refer a license request to the server that is positioned the shortest distance from client terminal 26a. To that end, client terminal 26a would transmit a license request to the server having a geographical association indicating that it is the shortest distance away. It should be understood, however that the priority levels associated with servers 25a, 25b, 25c and 25d may be based upon any criteria desired. For example, client terminal 26a could transmit a license request to the closest server that has an organizational association that is common with client terminal 26a, independent of the server's distance from client terminal 26a.

In addition to priority levels defined by the aforementioned geographical, organizational and political associations, the priority levels may be based upon other parameters, as well, such as the operational parameters associated with the server 25a, 25b, 25c, and 25d. For example, a server 25a, 25b, 25c and 25d may be provided with a highest priority level, independent of the geographical, organizational or political association of the same, because the server provides the fastest data access rate, or the greatest number of access connections when compared with all other servers in data communication over network 37.

Another embodiment of the present invention takes advantage of the replica features associated with the LDAP protocol to process license requests in the face of a catastrophic failure of the master license compliance program. To that end, created are additional copies of the master license compliance program referred to as replica license compliance programs. The replica license compliance programs are stored on servers other than the server upon which the master license compliance program is stored. The servers upon which the replica license compliance programs are stored may be disposed remotely from each other, as well as from the server upon which the master license compliance program is stored and the client terminal.

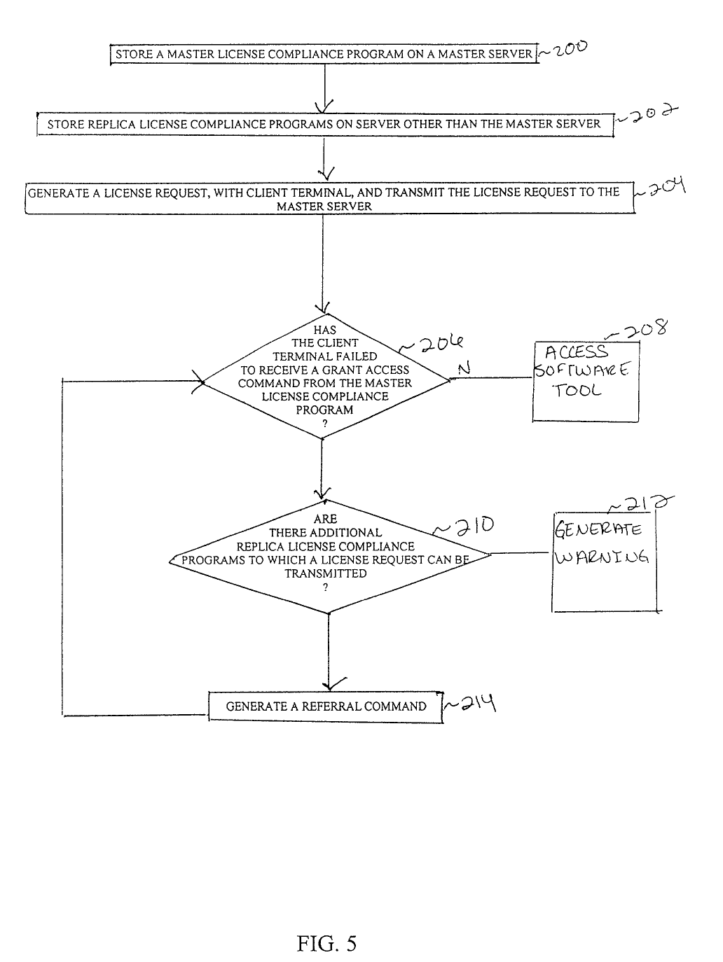

Referring to FIGS. 2 and 5, in another exemplary license management technique, the master license compliance program is stored on a master server, such as server 25b at step 200. At step 202, replica license compliance programs are stored on servers other than master server 25b, such as servers 25a, 25c and 25d. At step 204, a license request, generated by client terminal 26a, is received by master server 25b. At step 206, it is determined whether client terminal 26a failed to receive a grant access command. Were the grant access command received, then access to the software tool would be provided at step 208. Otherwise, the technique would proceed to step 210 and client terminal 26a determines whether there are any remaining replica license compliance programs from which to obtain a grant access command. Were there none, then at step 212 a warning is generated by client terminal 26a, as discussed above. Otherwise, at step 214, client terminal 26a executes a replica referral subroutine to generate a referral command. After the referral command has been generated, the technique returns to step 206. Steps 206, 210 and 214 are repeated until access to the software tool has been granted at step 208, or a warning is generated at step 212. In this manner, the referral subroutine may sequentially transmit a license request to the referred license compliance program contained on each of servers 25a, 25c and 25d. The sequence in which servers 25a, 25c and 25d receive a license request may be defined as stated above with respect to FIGS. 2 and 4. An advantage with this technique is that it enables the processing of license requests in the face of catastrophic failure of the master license compliance program due, for example, to corruption of the master license program or failure of server 25b.

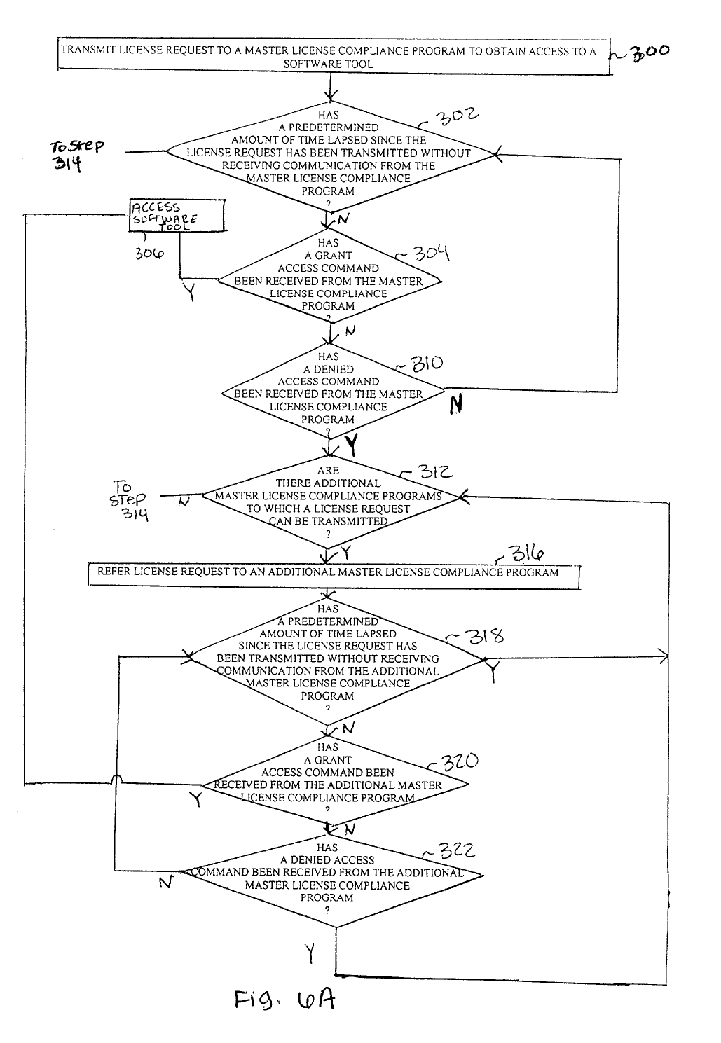

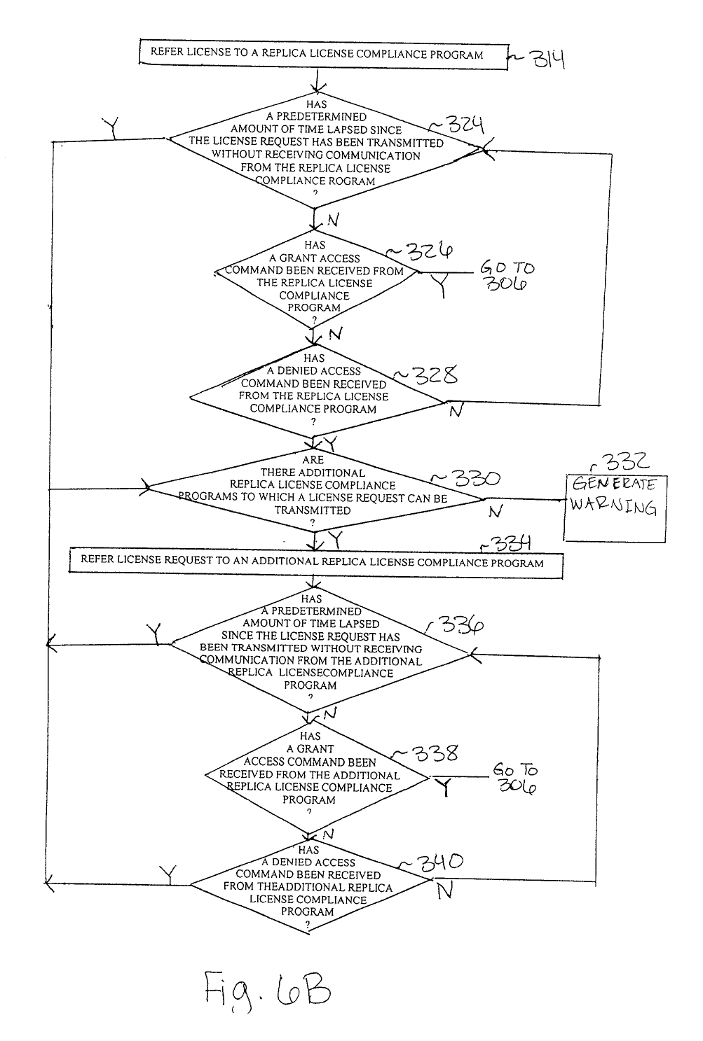

Referring to FIGS. 2, 6a and 6b, yet another exemplary license management technique in accordance with the present invention, the license management techniques set forth above are combined. This maximizes the availability of license rights available over network 27 in view of catastrophic failure of a master license compliance program or the exhaustion of rights under the same. To that end, at step 300, a client terminal, such as client terminal 26a transmits a license to the master license compliance program to obtain access to a software tool. At step 302, client terminal 26a determines whether a predetermined amount of time has lapsed since the license request was transmitted, without receiving a command from the master license compliance program. Were this not the case, the technique proceeds to step 304, wherein client terminal 26a determines whether a grant access command has been received. Were this the case, then the technique proceeds to step 306 and client terminal 26a is granted access to the software tool. Otherwise, client terminal 26a determines whether a deny access command has been received from the master license compliance program at step 310. Were a deny access command not received, the technique would return to step 302. Otherwise, the technique would continue to step 312, wherein client terminal 26a determined whether there are additional master license compliance programs to which a license request can be transmitted. If not, the technique proceeds to step 314 wherein client terminal refers a license request to a replica license compliance program.

Were there additional master license compliance programs to which a license request could be transmitted, then at step 316, client terminal 26a refers the license request thereto. At step 318, client terminal 26a determines whether a predetermined amount of time has lapsed since the license request to the additional master license compliance program was transmitted, without receiving a communication from the master license compliance program. Were this not the case, the technique proceeds to step 320, wherein the client terminal determines whether a grant access command has been received. Were this the case, then the technique proceeds to step 306 and client terminal 26a is granted access to the software tool. Otherwise, client terminal 26a determines whether a deny access command has been received from the master license compliance program at step 322. Were a deny access command not received, the technique would return to step 318. Otherwise, the technique would continue to step 312.

At step 314, the license request from client terminal 26a is transmitted to a replica master compliance program. This may be in response to a predetermined amount of time lapsing since the license request was transmitted to the master server 25b, at step 302. Alternatively, step 314 occurs in response to there being no additional master license compliance program wherein client terminal 26a determined whether there are additional master license compliance programs to which a license request can be transmitted, at step 312.

At step 324, client terminal 26a determines whether a predetermined amount of time has lapsed since the license request was transmitted, without receiving a command from the replica license compliance program. Were this not the case, the technique proceeds to step 326, wherein the client terminal determines whether a grant access command has been received. Were this the case, then the technique proceeds to step 306 and client terminal 26a is granted access to the software tool. Otherwise, client terminal 26a determines whether a deny access command has been received from the replica license compliance program at step 328. Were a deny access command not received, the technique would return to step 324. Otherwise, the technique would continue to step 330, wherein client terminal 26a determined whether there are additional replica license compliance programs to which a license request can be transmitted. Were there no additional replica license compliance programs, then the technique would proceed to step 332 and a warning would be generated by client terminal 26a. The warning would indicate that access to the software tool could not be granted, because no license rights were available.

Were it determined, at step 330, that there were additional replica license compliance programs available, the technique would continue to proceed to step 334, where the license request would be referred to the additional replica license compliance programs. Thereafter, at step 336, client terminal 26a determines whether a predetermined amount of time has lapsed since the license request was transmitted, without receiving a command from the replica license compliance program. Were this the case, the technique would return to step 330. Otherwise, the technique proceeds to step 338, wherein the client terminal determines whether a grant access command has been received. Were a grant access command received by client terminal 26a, then the technique proceeds to step 306 and client terminal 26a is granted access to the software tool. Otherwise, client terminal 26a determines whether a deny access command has been received from the replica license compliance program at step 340. Were a deny access command not received, the technique would return to step 336. Otherwise, the technique would continue to step 330.

Although the foregoing has been discussed with respect to managing software license, it should be understood that the present invention may be employed to manage access to any type of software over a network. Thus, the embodiments of the present invention described above are exemplary and the scope of the invention should, therefore, be determined not with reference to the above description, but instead should be determined with reference to the appended claims along with their full scope of equivalents.

What is claimed is:

1. A method of managing software licensing over a network using a master license compliance program, said method comprising:
providing multiple copies of license compliance software programs, with said master license compliance program and said multiple copies defining a plurality of license compliance programs, each of which has software license rights associated therewith;
associating a referral priority level to each of said plurality of license compliance software programs, defining a referral sequence; and
receiving, with said master license compliance program, a license request, and referring said license request to said multiple copies in accordance with said referral sequence to obtain license authorization were said master license compliance program to fail to generate a grant access command in response to said request.

2. The method as recited in claim 1 wherein receiving and referring said license request further includes referring said license request to said multiple copies were said master license compliance program disabled.

3. The method as recited in claim 1 wherein receiving and referring said license request further includes referring said license request to said multiple copies were said request determined to fall outside of the software license rights associated with said master license compliance program.

4. The method as recited in claim 1 further including transmitting a grant access command from a first of said multiple copies in said sequence in which said request were found to be in compliance with said software license rights associated therewith.

5. The method as recited in claim 1 further including disposing one of said multiple copies remotely from the remaining copies of said multiple copies and remotely disposing said master compliance program with respect to said multiple copies, with the priority associated with each of said multiple copies being a function of a geographical distance between said each of said multiple copies and said master license compliance program, and arranging said sequence so that said license request is transmitted to the multiple copies located geographically closer to said master license compliance program before being transmitted to the multiple copies positioned geographically further from said master license compliance program.

6. The method as recited in claim 1 further including storing said multiple copies on multiple servers, with the server upon which one of said multiple copies is stored being positioned remotely from the servers upon which said remaining copies of said multiple copies are stored and storing said master compliance program on a server that is remotely positioned with respect to the servers upon which said multiple copies are stored, with the priority associated with each of said multiple copies being a function of an amount of access bandwidth associated with said server storing said each of said multiple copies, and arranging said sequence so that said license request is transmitted to copies located on servers having higher access bandwidth before being transmitted to copies stored on servers having lower access bandwidth.

7. The method as recited in claim 1 wherein associating referral priority levels further includes associating referral priority levels of each of said multiple copies to one of a set of priority levels consisting of political information, geographical information and organizational information, defining said referral sequence, and further including storing said multiple copies on said multiple servers, with said server upon which one of said multiple copies is stored being positioned remotely from said servers upon which the remaining multiple copies are stored, and storing said master compliance program on said server that is remotely positioned with respect to said servers upon which said multiple copies are stored.

8. The method as recited in claim 1 further including storing said multiple copies on multiple servers, defining replica servers, with said replica server upon which one of said multiple copies is stored being positioned remotely from the replica servers upon which said remaining multiple copies are stored and storing said master compliance program on a master server that is remotely positioned with respect to said replica servers upon which said multiple copies are stored, wherein receiving and referring said license request further includes receiving, with one of said plurality of replica servers, defining a receiving server, a local license request and a referred license request, with said receiving server processing said local and referred license request before processing said remote license request to determine license authorization.

9. The method as recited in claim 1 further including storing said multiple copies on multiple servers, defining replica servers, with said replica server upon which one of said multiple copies is stored being positioned remotely from the replica servers upon which said remaining multiple copies are stored and storing said master compliance program on a master server that is remotely positioned with respect to the replica servers upon which said multiple copies are stored, wherein receiving and referring said license request further includes receiving, with one of said plurality of replica servers, defining a receiving server, a first license request from a first client and a second license request from a second client, and prioritizing processing of said first and second license requests in accordance with a predetermined relative ranking between said first and second clients, with said receiving server processing said client with a greater rank before processing the remaining client to determine license authorization.

10. A computer product having a computer readable medium that contains a program to manage software licensing among a client terminal and a plurality of servers in data communication over a network, said computer product comprising:
computer code to store a master license compliance program on one of said plurality of servers and a copy of a license compliance software program on a subset of the remaining servers of said plurality of servers, defining multiple copies of license compliance software programs, with said master compliance program and each of said multiple copies having each of software license rights associated therewith;
computer code to associate a referral priority level to each of said multiple copies, defining a referral sequence; and
computer code to receive, with said master license compliance software program, a license request, and refer said license request to said multiple copies in accordance with said referral sequence to obtain license authorization were said master license compliance program to fail to generate a grant access command in response to said request.

11. The computer product as recited in claim 10 wherein code to receive further includes a subroutine to refer said license request to said multiple copies were said master license compliance program disabled.

12. The computer product as recited in claim 10 wherein said code to receive further includes a subroutine to refer said license request to said multiple copies were said request determined to fall outside of the software license rights associated with said master license compliance program.

13. The computer product as recited in claim 10 further including code to transmit a grant access command from a first of said multiple copies in said sequence in which said request were found to be in compliance with the software license rights associated therewith.

14. The computer product as recited in claim 10 wherein each of the servers upon which one of said multiple copies is stored has an access bandwidth associated therewith, with said computer code to store further including a subroutine to transmit said license request so that said license request is transmitted to copies located on servers having higher access bandwidth before being transmitted to copies stored on servers having lower access bandwidth.

15. The computer product as recited in claim 10 wherein said code to associate referral priority levels further includes a first subroutine to associate referral priority levels of each of said multiple copies to one of a set of priority levels consisting of political information, geographical information and organizational information, defining a referral sequence.

16. The computer product as recited in claim 10 wherein said multiple copies of said license compliance software program are each a copy of said master license compliance program, defining a plurality of replica copies, wherein said code to receive said license request further includes a subroutine to receive, with one of said plurality of replica copies, defining a receiving copy, a local license request and a referred license request, with said receiving copy having computer code to process said local and referred license request before processing said remote license request to determine license authorization.

17. A computer network to manage software licensing, said network comprising:
a client terminal; and
a plurality of a servers, one which stores a master license compliance program, defining a master server, with a subset of the remaining servers of the plurality of servers storing a copy of a license compliance software program, with said master license compliance program and said license compliance software program stored on said subset defining a plurality of license compliance programs, each of which has software license rights and a referral priority level associated therewith, defining a referral sequence, with said master license compliance program adapted to receive a license request, and refer said license request to said multiple copies in accordance with said referral sequence to obtain license authorization were said master license compliance program to fail to generate a grant access command in response to said request.

18. The network as recited in claim 17 wherein said master server is positioned remotely with respect to said remaining servers with each server of said subset being disposed remotely with respect to the remaining servers of said subset, with the priority associated with each of said plurality of license compliance programs being a function of an amount of access bandwidth associated with the server storing said each of said plurality of license compliance programs, so that said license request is transmitted to said plurality of license compliance programs stored on servers associated with said subset having higher access bandwidth before being transmitted to the servers associated with said subset having lower access bandwidth.

19. The network as recited in claim 17 wherein said priority level associated with each of said plurality of license compliance programs stored on servers associated with said subset consisting of political, geographical and organizational information.

20. The network as recited in claim 17 further including storing multiple copies of said master license compliance program on multiple servers, defining replica servers, with the replica server upon which one of said multiple copies is stored being positioned remotely from the replica servers upon which the remaining multiple copies are stored and storing said master license compliance program on a master server that is remotely positioned with respect to said replica servers upon which said multiple copies are stored, wherein receiving and referring said license request further includes receiving, with one of said plurality of replica servers, defining a receiving server, a local license request and a referred license request, with said receiving server processing said local and referred license request before processing said remote license request to determine license authorization.
